(19) United States
(12) Patent Application Publication
(10) Pub. No.: US 2017/0011648 A1
(43) Pub. Date: Jan. 12, 2017

(54) Firefighter's Ladder-Throwing Training Apparatus

(71) Applicant: Elisabeth Curry, Santa Clarita, CA (US)

(72) Inventor: Elisabeth Curry, Santa Clarita, CA (US)

(21) Appl. No.: 14/794,660

(22) Filed: Jul. 8, 2015

(51) Int. Cl. G09B 19/00

(52) U.S. Cl. CPC G09B 19/00

(57) ABSTRACT

A firefighter's ladder-throwing training apparatus (FLTTA) that allows firefighters to train and practice a ladder-throwing technique consisting of grasping a ladder located in a side position and moving the ladder to a front usable position. The FLTTA consists of four major elements: a ladder frame, a composite rod, a universal joint and an apparatus base. The ladder frame includes side rails that encompass a plurality of rungs and a ladder base. The composite rod includes an upper rotatable section and a lower stationery section with each section having an upper edge and a lower edge. The upper edge of the rotatable section is attached to the ladder base. The lower edge of the rotatable section is attached to an upper segment of the universal joint and the lower segment of the universal joint is attached to the upper edge of the stationary section. The lower edge of the stationary section is rigidly attached to the apparatus base.

### TECHNICAL FIELD

The invention generally pertains to devices used to train firefighters, and more particularly to a firefighter's ladder-throwing apparatus that allows a single firefighter to manually grasp and rotate a ladder from a side facing position to a front facing position.

### BACKGROUND ART

Almost every profession in the world requires a certain amount of knowledge. The type and actual amount of knowledge varies among all the different professions. There are also some professions that require physical capability or strength. As with knowledge, the type and amount of physical capability or strength required can vary, depending on the requirements of the profession.

One example of a profession that requires both knowledge and physical capability is a firefighter. The demands put on a firefighter are significant, and a firefighter must have knowledge and physical capability to not only perform the job, but also to survive in what are sometimes extremely dangerous situations.

In years past it was thought that only men possess the necessary physical capability/strength to be a “fireman”, but as time has progressed and most of the world has become more enlightened, women have proven that they too can handle all the requirements of being a firefighter. This is noted because the knowledge and physical capability/strength requirements to be a firefighter (as well as may other male and female professions) are the same for men and women.

The knowledge required is based on the situations and scenarios that will be encountered as a firefighter. The physical capability/strength required is a the ability to perform physical actions based on the unique situations/scenarios experienced by a firefighter when he/she responds to a variety of fire or non-fire emergencies. In other words, a firefighter must be more physically capable/stronger than a common man or woman. In addition, a firefighter must be able to perform certain actions, such as climbing, and to utilize/handle certain equipment, such as the protective clothing or various types of ladders. In order to accomplish these actions, many firefighters perform special training or exercises.

One example of a special, or job-specific, exercise is the handling, lifting and using a ladder. A firefighter must be able to lift and maneuver a ladder, which typically has significant weight. Due to a ladder's size and unique design/shape it is often difficult to perform exercises with a ladder. What is needed is an exercise/training device that is specifically designed to provide a user with the feel and appearance of a ladder while not being limited by the large, cumbersome nature of an actual ladder. A ladder training/exercise device would optimally allow a person to experience what is required when lifting and handling a ladder in a variety of different ways. By use of a device such as this, a person, such as a firefighter, can regularly exercise and develop the physical capability/strength required to access and use a ladder by performing the actions that are specifically required.

A search of the prior art did not disclose any literature or patents that read directly on the claims of the instant invention. However, the following U.S. patents are considered related:

| PAT. NO. | INVENTOR | ISSUED |
|---|---|---|
| 3,876,000 | Bush et al | 8 Apr. 1975 |
| 4,360,198 | Waulters | 23 Nov. 1982 |
| 4,986,535 | Hull et al | 22 Jan. 1991 |
| 7,699,756 | Piane, Jr. | 20 Apr. 2010 |

The U.S. Pat. No. 3,876,200 patent discloses an exercising device comprising a ladder and a frame pivotally mounted within the ladder uprights. The frame has rollers with vacuum cups for massage purposes including a manual crank for rotting the rollers while a user is resting on the frame rollers.

The U.S. Pat. No. 4,360,198 patent discloses a self-supporting frame for exercising. The frame has a pair of spaced standards each having an upper and a lower end. Each standard has a respective base attached to a lower end thereof for engaging a floor surface and supporting the frame in an upright position. Each standard also has secured thereto a lower rod respectively. The rods extend outward in opposed directions and cantilever from a respective standard lower end. The frame is weighted with a pair of plates each having an aperture therethrough for slidably receiving one of the rods. The plates are supported by and connected to a lower end of the standards. A bar extends between and is attached to upper ends of each standard, the frame thereby being liftable by a person grasping the bar.

The U.S. Pat. No. 4,986,535 patent discloses a therapy and exercise device which is substantially a two-step hollow ladder partially filed with a viscous fluid such as water. The device also contains ballast such as ball bearings for additional weight, with the fluid and ballast shifting from one end of the ladder to the other when one end is held lower than the other, thus increasing weight slowly from one end to the other.

The U.S. Pat. No. 7,699,756 patent discloses an apparatus for removably mounting an exercise apparatus to a supporting structure such as a ladder-like structure. Various types of mounting apparatus with specially designed brackets having multiple interchangeable parts, attachments and accessories, are used to facilitate easy and quick mounting of several types of exercise apparatus to the supporting structure.

For background purposes and indicative of the art to which the invention relates, reference may be made to the following remaining patents found in the patent search.

| PAT. NO. | INVENTOR | ISSUED |
|---|---|---|
| Des/285,711 | Paul | 16 Sep. 1986 |
| 4,262,901 | Faust | 21 Apr. 1981 |
| 4,557,479 | Guibert | 10 Dec. 1985 |
| 4,770,273 | McMakin et al | 13 Sep. 1988 |
| 4,923,194 | Montgomery | 8 May 1990 |
| 5,145,475 | Cares | 8 Sep. 1992 |
| 6,447,427 | Myrland et al | 10 Sep. 2002 |
| 2005/0143235 | Park | 30 Jun. 2005 |
| 2007/0032357 | Piane, Jr. | 8 Feb. 2007 |
| 2008/0051270 | Lazar | 28 Feb. 2008 |
| 2011/0124476 | Holley | 26 May 2011 |

### DISCLOSURE OF THE INVENTION

The firefighter's ladder-throwing training apparatus (FLTTA) is designed to facilitate a firefighter practicing and training to use/lift a ladder and more specifically to remove a ladder from a side position to a useable front-facing position.

In its basic design configuration the FLTTA is comprised of a ladder frame that includes two side rails that enclose a plurality of rungs and a ladder base, a composite rod having an upper rotatable section and a lower stationary section, a universal joint, and an apparatus base.

The rotatable section has an upper edge that is attached to the ladder base and a lower edge that is attached to an upper segment of the universal joint. The stationery section has an upper edge that is attached to a lower segment of the universal joint and the lower edge is attached to the apparatus base

In view of the above disclosure, the primary object of the invention is to provide a FLTTA that allows a firefighter to practice the maneuver of grasping and throwing a side positioned ladder to a useful front facing position.

In addition to the primary object of the invention it is also an object of the invention to provide an FLTTA that:
can also be used to perform a variety of basic exercising routines,
can be manufactured from a variety of materials,
can be used for other ladder lifting and using exercises,
can be made in a variety of sizes,
can be used by both men and women,
is durable and long-lasting,
can be permanent attached at a specific location, or can be transferred for use, and
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is an orthographic side view of a firefighter utilizing a firefighter's ladder-throwing training apparatus.

FIG. 2 is a cross-sectional front elevational view of a first attachment means that secures an upper section of a composite rod to a ladder frame and that secures the lower section of the rod to an apparatus base.

FIG. 3 is a cross-sectional front elevational view of a second attachment means that secures the upper section of the composite rod to the ladder frame and a third attachment means that secures the lower section of the rod to an apparatus base.

FIG. 4 is a cross-sectional and elevational view of a first attachment means that secures the upper section of the rod to the ladder frame, and a fourth attachment means that secures the lower section of the rod to a rod attachment structure.

FIG. 5 is an orthographic top view showing the interface of a universal joint with the lower edge of the rotatable rod and with the upper edge of the stationary rod.

### BEST MODE FOR CARRYING OUT THE INVENTION

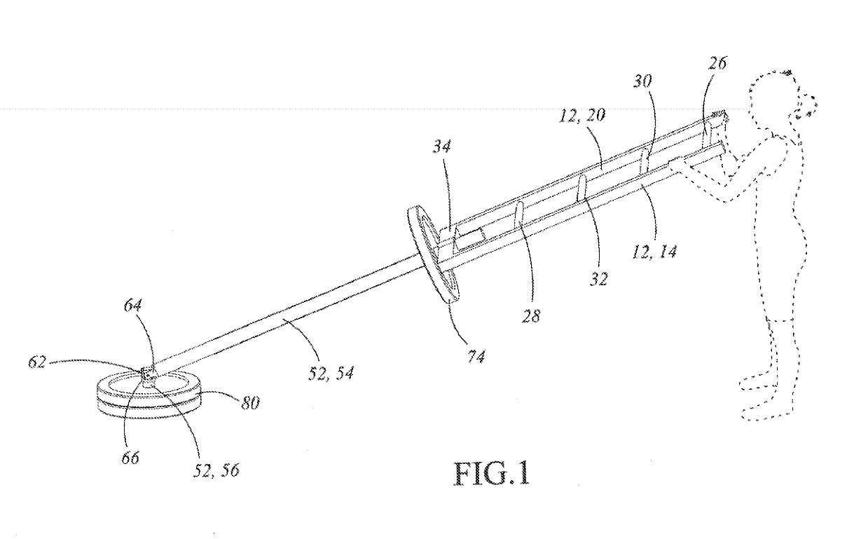

The best mode for carrying out the invention is presented in terms that disclose a preferred embodiment of a firefighter's ladder-throwing training apparatus (FLTTA 10). The preferred embodiment, as shown in FIGS. 1-5, is comprised of four major elements: a ladder frame 12, an apparatus base 40, a composite rod 52 and a universal joint 62.

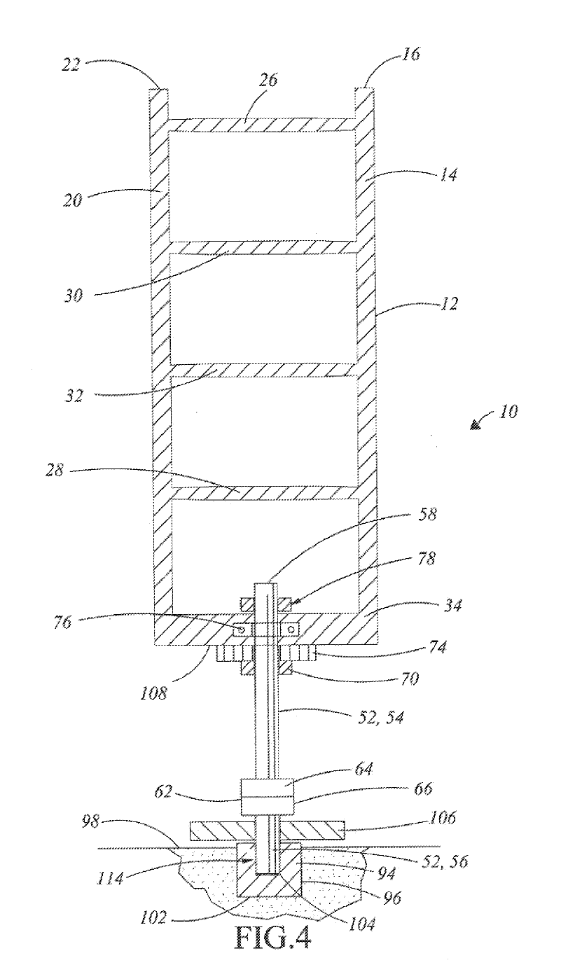

The ladder frame 12, as shown in FIGS. 1-4, is comprised of a right vertical rail 14 having an upper edge 16 and a lower edge 18, and a left vertical rail 20 having an upper edge 22 and a lower edge 24. Between the right and left vertical rails 14,20 is located an upper rung 26 that is attached adjacent the upper edges 16,22, a lower rung 28, a first mid-rung 30 and a second mid-rung 32. The two mid-rungs 30,32 are evenly spaced between the upper rung 26 and the lower rung 28, as shown in FIGS. 1 and 4. To complete the structure of the ladder frame 12, a ladder base 34 is attached between and aligned with the lower edges 18,24 of the right and left vertical rails 14,20. The ladder base 34 also has a substantially centered rod bore 36. It should be noted that the number of rungs used is not limited, since the FLTTA 10 can effectively function with at least one rung. The number of rungs is preferably maintained at a low number to provide a FLTTA 10 having a size and weight that is manageable.

The right and left vertical rails 14,20 are made of hollow square or rectangular tubes that are dimensioned to simulate the rails of a firefighter's ladder, likewise the rungs have a circular cross-section 33 that are dimensioned to simulate the rungs of the firefighter's ladder. While these types of tubes and rungs are preferred, other dimensions/shapes of tubes and rungs can also be utilized.

The ladder frame 12 has a length that ranges from 48 to 84 inches, and is preferably constructed as a single integrated unit that is made of a material selected from the group consisting of metal, plastic and wood. If aluminum is used, it can be anodized in a selectable color, and other metals can be plated or powder-coated.

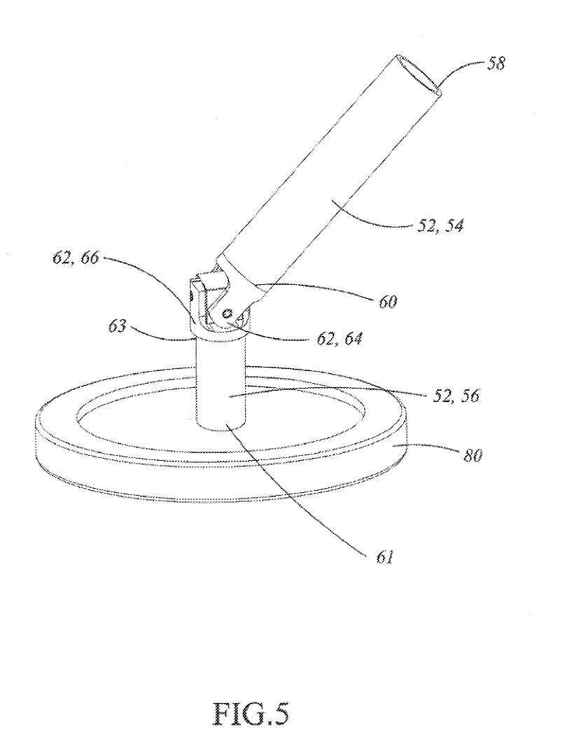

The composite rod 52, as shown in FIGS. 1-5, has an upper rotatable section 54 and a lower stationary section 56. The upper rotatable section 54 has an upper edge 58 and a lower edge 60 that has attached an upper segment 64 of the universal joint 62, as best shown in FIG. 5. The lower stationary section 56 has a lower edge 61 and an upper edge 63 that has attached a lower segment 66 of the universal joint 62. The overall length of the composite rod 52 ranges from 60 inches to 84 inches.

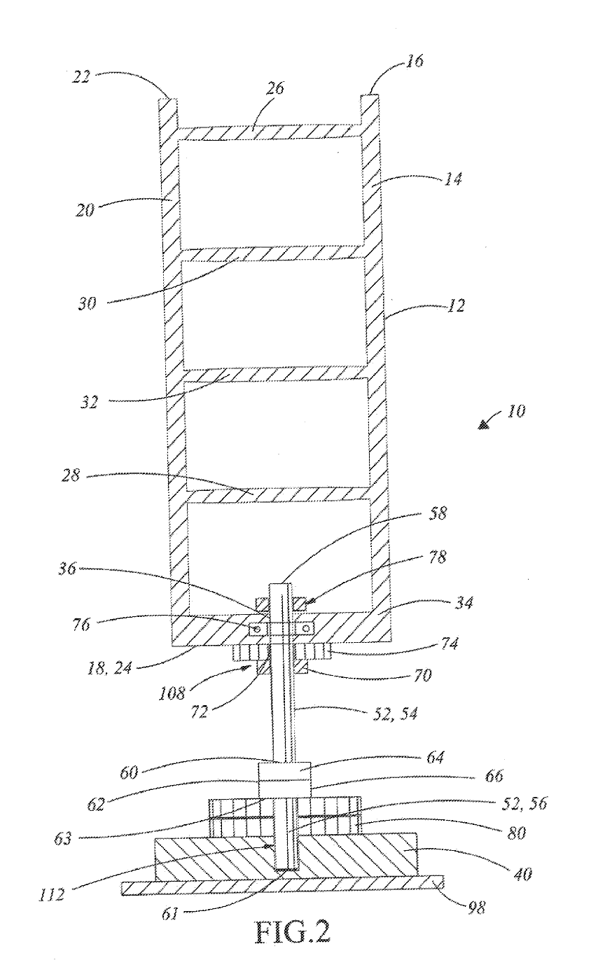

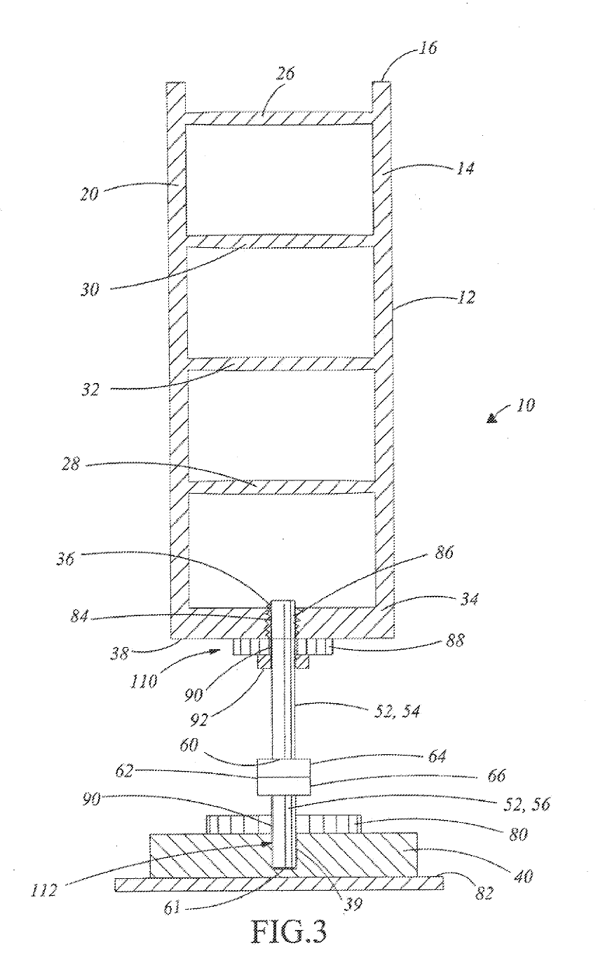

The upper rotatable section 54 of the composite rod 52 is secured to the ladder base 34 by a first attachment means 108, as shown in FIG. 2, or by a second attachment means 110, as shown in FIG. 3. Likewise, the lower stationery section 56 of the composite rod 52 is secured to the apparatus base 40 by a third attachment means 112 or by a fourth attachment means 114, as shown in FIG. 4.

The first attachment means 108, as shown in FIG. 2, for securing the upper rotatable section 54 of the composite rod 52 to the ladder base 34 is accomplished, by sequentially inserting the rod 52 through an upper weight collet 70, a rod bore 72 located on at least one upper weight 74, a rod sleeve 76 that is attached to the ladder base 34 and that circumvents the rod bore 72, and into a rod collet 78 that secures the rotatable section 54 of the rod 52.

The second attachment means 110, as shown in FIG. 3, for securing the upper rotatable section 54 of the composite rod 52 to the ladder base 32 is accomplished by using a ladder base 34 having a threaded bore 84 and the upper rotatable section 54 of the rod 52 having a complimentary set of interfacing threads 86. The second attachment means 110 also has at least one rod supporting structure 88 having a rod bore 90 dimensioned to receive the upper rotatable section 54 of the rod 52 and that interfaces with the lower surface 38 of the ladder base 34 and that is held thereto by a rod collet 92.

The third attachment means 112, as also shown in FIG. 3, for securing the lower stationary section 56 of the composite rod 52 to the apparatus base 40 is accomplished by sequentially inserting the lower stationary section 56 of the rod 52 through a rod bore 90 located on at least one rod supporting structure 80 and into a cavity 39 located on the apparatus base 40 which interfaces with a substantially flat surface 82.

The fourth attachment means 114, as shown in FIG. 4, for securing the lower section 56 of the composite rod 52 is accomplished by utilizing a rod encasement structure 94 that is placed into a hole 96 located in a substantially flat surface 98. The structure 94 has a sealed lower surface 102 that forms a cavity 104 that is dimensioned to receive and support the lower stationary section 56 of the composite rod 52. The fourth attachment means 114 can also include an optional rod supporting disk 106 that is inserted into the lower section 56 of the composite rod 52 between the lower segment 66 of the universal joint 62 and the rod encasement structure 94.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A firefighter's ladder-throwing training apparatus (FLTTA) comprising:
a) a ladder frame having:
(1) a right vertical rail having an upper edge and a lower edge,
(2) a left vertical rail having an upper edge and a lower edge,
(3) an upper rung located adjacent the upper edges and between the right and left vertical rails,
(4) a lower rung,
(5) a pair of evenly spaced rungs located between the upper rung and the lower rung,
(6) a ladder base located between and aligned with the lower edges of the right and left vertical rails and having a substantially centered rod bore,
b) an apparatus base having a rod cavity, an upper surface and a lower surface that interfaces with a substantially flat exterior surface,
c) a composite rod having an upper rotatable section and a lower stationary section, wherein the upper rotatable section has an upper edge and a lower edge that has attached an upper segment of a universal joint, wherein the lower stationary section has a lower edge and an. upper edge that has attached a lower segment of said universal joint,
d) means for securing the upper section of said rotatable rod to the ladder base of said ladder frame, and
e) means for securing the lower section of said rod to said apparatus base.

2. The FLTTA as specified in claim 1 wherein the right and left vertical rails are comprised of hollow square tubes that simulate the rails of a firefighter's ladder.

3. The FLTTA as specified in claim 2 wherein the rungs have a circular cross-section that simulates the front of a firefighter's ladder.

4. The FLTTA as specified in claim 3 wherein the rungs are integral with the vertical rails.

5. The FLTTA as specified in claim 3 wherein the rungs are attached to the vertical rails by an attachment means.

6. The FLTTA as specified in claim 5 wherein the attachment means is comprised of a welding process.

7. The FLTTA as specified in claim 1 wherein said means for securing the upper rotatable section of said composite rod to the ladder base is accomplished by sequentially inserting said rod through an upper weight collet, the rod bore located on said at least one upper weight, a rod sleeve that is attached to the ladder base and that circumvents the rod bore, and into a rod collet that secures said rod.

8. The FLTTA as specified in claim 1 wherein said means for securing the lower stationary section of said rotatable rod comprises sequentially inserting the lower section of said rod through the rod bore on at least one rod supporting structure and into a cavity on said apparatus base which interfaces with a substantially flat surface.

9. The FLTTA as specified in claim 1 wherein said means for securing the upper rotatable section of said composite rod is accomplished by using a ladder base having a threaded bore and the upper section of said rod having a complimentary set of interfacing threads.

10. The FLTTA as specified in claim 9 further comprising at least one rod supporting structure having a rod bore dimensioned to receive the upper rotatable section of said rod and that interfaces with the lower surface of the ladder base and that is held thereto by a rod collet.

11. The FLTTA as specified in claim 1 wherein said means for securing the lower stationary section of said rotatable rod comprises a rod encasement structure placed into a hole located in a substantially flat surface, wherein said structure having a sealed lower surface that forms a cavity dimensioned to receive and maintain the lower stationary section of said rotatable rod.

12. The FLTTA as specified in claim 11 further comprising a rod supporting disk that is inserted into the lower stationary section of said rotatable rod between the lower segment of said universal joint and the rod encasement structure.

13. The FLTTA as specified in claim 1 wherein said ladder frame is constructed of a single integrated unit.

14. The FLTTA as specified in claim 13 wherein the single integrated unit is made of a material selected from the group consisting of metal, plastic and wood.

15. The FLTTA as specified in claim 14 wherein said metal is comprised of aluminum.

16. The FLTTA as specified in claim 15 wherein the aluminum is anodized in a selectable color.

17. The FLTTA as specified in claim 11 wherein said composite rod has a length that ranges from 60 inches to 84 inches.

18. The FLTTA as specified in claim 11 wherein said ladder frame has a length that ranges from 48 inches to 84 inches.
